(19) United States
(12) Patent Application Publication
(10) Pub. No.: US 2004/0078118 A1
(43) Pub. Date: Apr. 22, 2004

(54) Method and device for monitoring equipment

(76) Inventor: Jurgen Binder, Berlin (DE)

Correspondence Address: Mallinckrodt & Mallinckrodt, Suite 510, 10 Exchange Place, Salt Lake City, UT, 84111, US

(21) Appl. No.: 10/450,494

(22) PCT Filed: Dec. 7, 2001
(86) PCT No.: PCT/EP01/14376

(30) Foreign Application Priority Data
Dec. 15, 2000 (DE) 100 64 469.4
Feb. 2, 2001 (DE) 101 05 229.4
Sep. 28, 2001 (DE) 101 48 9983.5

(51) Int. Cl. G06F 17/00

(52) U.S. Cl. 701/1; 340/426.1

(57) ABSTRACT

The invention relates to a device for controlling an appliance, which cooperates with a human operator, wherein the appliance comprises an appliance-side safety device (10), which can interact with an enabling element (12) provided with memory means (80,82,84) and associated with a particular, authorized human operator, the appliance being operable only after interaction with the enabling element (12). In one application the occurrences to be watched can be stored in the memory means (80,82,84) of the enabling element, for example for watching motor vehicles with regard to unacceptably long driving times of a particular driver. In another application, the control means of aircraft are watched to ensure that the aircraft can be flown only by an authorized pilot. Invariable body characteristics of the driver or pilot, for example a finger print, are stored in the enabling element. The real body characteristics are detected by sensors and are compared with the stored ones. The vehicle or aircraft can only be used, if detected and stored body characteristics are identical.

### TECHNICAL FIELD

The invention relates to a method of controlling an appliance, which cooperates with a human operator.

Furthermore, the invention relates to a device for controlling an appliance, which cooperates with a human operator, wherein the appliance comprises an appliance-side safety device, which can interact with an enabling element provided with memory means and associated with a particular, authorized human operator, the appliance being operable only after interaction with the enabling element.

Furthermore, the invention relates to an enabling element, by means of which a human operator can cooperate with an appliance.

One application of the invention is the control of motor vehicles to detect unacceptably long driving times of a particular driver. Another application is the control of a motor vehicle to detect exceeding of a predetermined maximum speed permissible for the motor vehicle.

In particular with commercial vehicles such as trucks or busses, serious accidents occur again and again by the driver being at the wheel for too long without interruption. Then, the driver gets tired and may start to sleep or may react too late or wrongly to dangerous situations. Therefore, there are legal regulations as to how many hours is allowed to drive within a certain period of time, and how many hours he has to rest between the missions. Therefore, it is necessary, to control the observation of the maximum permissible driving times and of the periods of rest.

Another application of the invention is the watching of the controls of aircraft, in order to ensure that the aircraft can be flown by an authorized pilot only.

The operation of aircraft imposes high requirements on the pilot. Pilot errors can result in considerable damage, if not in catastrophes. Separate licenses are required for the various types of aircraft, which licenses are granted after an appropriate training. It has to be ensured that a pilot not properly authorized is prevented from taking off with the aircraft.

A further problem from recent times is the hijacking of aircraft by terrorists. During such hijacking, it may be that the authorized pilots are forced at gun point to fly the aircraft to some airport given by the terrorist. “Suicide assassins” eliminate the pilots completely and then, as pilots themselves, steer the aircraft to a target such as a prominent building.

The invention relates to a method to counteract such aircraft hijacking.

### PRIOR ART

DE 32 40 773 C2 discloses an electronic device for monitoring the driving time performed by the driver of a motor vehicle. A vehicle-side safety device contains a clock and a computer with processor unit, main and program memories and read-write device. The safety device is switched on by an enabling element and, then, permits putting into operation of the motor vehicle. In DE 32 40 773 C2, the enabling element is a code card with memory means into which data can be written and from which data can be read. This code card is inserted into a slot of the safety device and, then, communicates with the safety device through an interface. At first, the driver's data stored on the code card and the driving time still permissible for this driver are read out from the code card. When the driver then drives the motor vehicle, the respective permissible remaining driving time is written back into the code card. Even if the driver, after termination of the mission, pulls the code card out of the safety device and continues to drive with another motor vehicle, the permissible remaining driving time will be taken into consideration for this further mission. When the legally permissible driving time is exceeded, the embodiment of De 32 40 773 C2 provides for blocking the motor vehicle by switching-off of the ignition device. Instead, of course, also an optical or acoustical warning signal may be generated or, for example in a cab, the taximeter may be disabled. Furthermore, in operation, operational data of the motor vehicle, for example the speed, are stored. Also these data are personally associated with the driver by the storing on the driver-specific code card. The driver is personally responsible for the observation of the prescribed driving and rest times and for the operational data stored on the code card.

The arrangement of DE 32 40 773 C2 leaves room for intentional manipulations. Thus, it is possible, for example, that a non-authorized person can put the appliance into operation with the enabling element of another person.

### DISCLOSURE OF THE INVENTION

It is an object of the invention to ensure that the appliance can be operated only by a specific, authorized human operator who is associated with the enabling element.

In the case of a motor vehicle, it is to be ensured that manipulation of the type described above, namely that a driver, after the maximum permissible driving time has been exceeded, continues to drive with the code card of another person, is made impossible.

In the case of the watching of the control means of aircraft, operation of the aircraft is to be enabled only by an authorized pilot, and operation by non-authorized persons is to be prevented.

According to the invention, this object is achieved by the steps of:

(a) making an enabling element, which is provided with memory means and associated with a particular, authorized human operator,

(b) storing an invariable body characteristic in the memory of the enabling element,

(c) releasing the appliance for operation by using the enabling element by the authorized human operator,

(d) during this use, carrying out a comparison of the body characteristic of the human operator with the stored body characteristic,

(e) preventing the release, when the body characteristics deviate from each other.

Furthermore, the object is achieved with a device mentioned in the beginning by means for storing an invariable body characteristic of the authorized human operator, means for recognizing this body characteristic of the human operator using the enabling element on the safety device, and means for comparing the recognized body characteristic with the body characteristic stored in the enabling element, putting into operation of the appliance after use of the enabling element being released then and only then when the recognized and stored body characteristics are identical.

Then, for the putting into operation of the appliance, for example a motor vehicle, the possession of an enabling element is not sufficient. The human operator must also have the body characteristics stored in the enabling element. In the case mentioned above of exceeding the maximum permissible driving time, the driver would not be able to continue driving with his own enabling element, because the remaining driving time stored therein has been reduced to zero or the total driving time has reached the maximum permissible value. He is also not able to drive with another enabling element which still has sufficient remaining driving time, because the body characteristic stored there is not identical with his own. Generally, putting into operation of the motor vehicle by anybody else than the owner of the particular enabling element is not possible.

In the case of the watching of the operation of an aircraft, each authorized pilot has an enabling element, for example in the form of a chip or code card or of a computer in the form of a flat, card-like housing. A body characteristic of this authorized pilot is stored in this enabling element in digital form, for example finger prints, voice characteristics or the structure of the iris in the eye. The enabling element may also contain further data, which are read into the safety device, for example the authorization for a particular type of airplane. The recognizing means of the safety device now compare the pilot's actual body characteristics with those stored in the enabling element and read in into the safety device. In the case of deviations, the control means, thus, for example, the control stick (or equivalent), throttle lever, flap lever and setting elements for the autopilot are compulsarily deactivated. Therefore, nobody else but the rightful owner of the enabling element will be able to put the aircraft into operation and take off.

If, in the case of a terrorist attack, the rightful pilot has been eliminated and somebody else attempts to fly the airplane in his place, this will be prevented by deactivation of the control means.

In order to avoid, in such a case, endangering of the aircraft and of its passengers, according to a further modification of the invention, provision can be made that the control means, in the case of a compulsory deactivation, are automatically changed over to a forced autopilot operation, which can no longer be influenced from within the aircraft. Then, the airplane will, at first, fly in a non-critical flight state with the operation of the autopilot. A terrorist or hijacker cannot change this situation.

Provision may be made, that upon changing over to forced autopilot operation, an alarm signal is transmitted to a ground station. Intervention means for remote control of the airplane from the ground station and for initiating an automatic or remote-controlled landing may be provided.

Preferably, the enabling element is characterized by means for storing an invariable body characteristic of an authorized human operator, means for recognizing these body characteristic of the human operator, means for comparing the stored and recognized body characteristics, and means for generating a release signal only when the recognized and the stored body characteristics are identical.

This offers advantages: Firstly, it may be possible to use such enabling element checking the body characteristic of the human operator in connection with already available safety devices, for example, such as that described in DE 32 40 773 C2, which do not provide for checking body characteristics. When using an enabling element of the invention, a release signal, which the conventional enabling element applies to the safety device, depends not only on the human operator being in possession of an authorized enabling element but, in addition, on the result of the comparison carried out in the enabling element being positive. The safety device need not be changed.

Such an enabling element “recognizing” the user can also be used in other connections. For example, when such an enabling element is used as a check or credit card or the like, it can be ensured that actually only the rightful owner of the check or credit card can use the same and is able, for example, to draw money from a teller machine. If such card permits access to a restricted area, it is ensured that only the rightful owner of the card can get this access.

Further modifications of the invention are the subject matter of dependent claims.

Embodiments of the invention are described hereinbelow with reference to the accompanying drawings.

### BRIEF DESCRIPTION OF THE DRAWINGS

FIG. 1 is a block diagram of a device for watching occurrences in an appliance, which are controlled by a human operator.

FIG. 2 is a schematic representation and illustrates the set up of the enabling element.

FIG. 3 is a schematic perspective illustration of the safety device with a card-like enabling element.

FIG. 4 is a block diagram of a device for watching the control means of aircraft.

FIG. 5 is a schematic-perspective view of a control stick with a sensor which responds to finger prints.

FIG. 6 is a schematic-perspective view of a safety device with an enabling element in the form of a chip card.

### PREFERRED EMBODIMENTS OF THE INVENTION

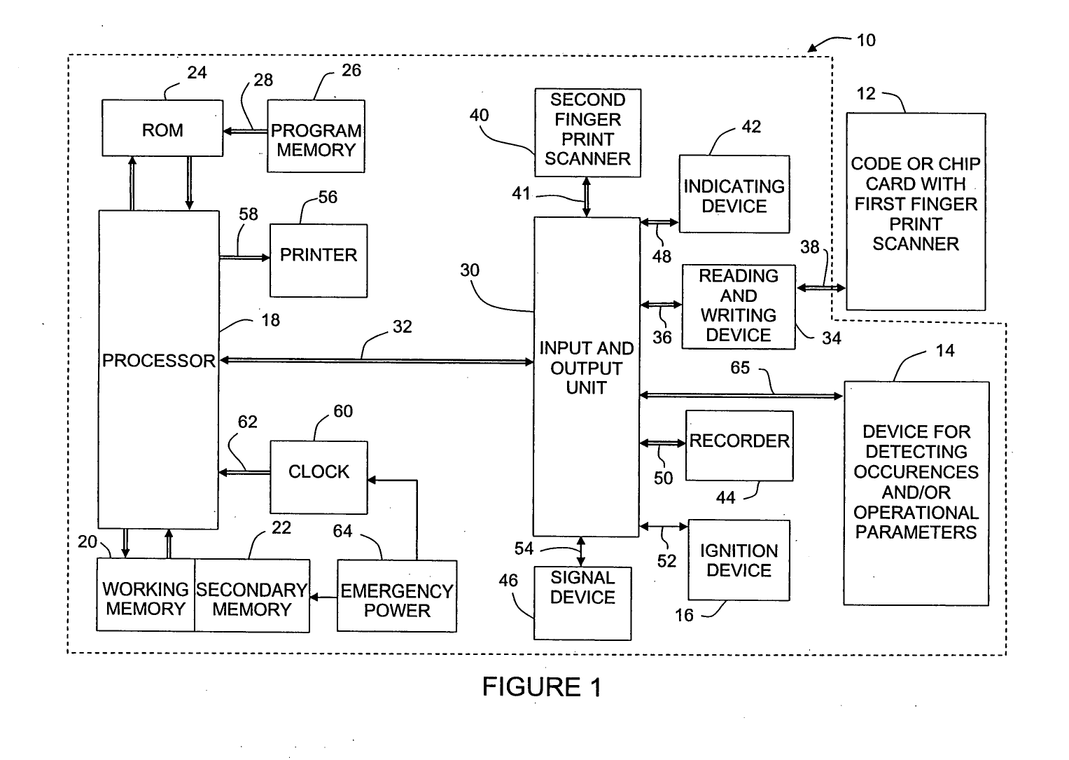

Referring to FIG. 1, numeral 10 generally designates a safety device. The safety device contains the elements still to be described enclosed by a dashed line. An enabling element 12 can be inserted into the safety device 10. In the described embodiment, the enabling element is a card-like element, which is insertable into an insert slot of the safety device. Numeral 14 generally designates components which detect occurrences in an appliance to be watched, in the present example in a motor vehicle, for example the speed of the motor vehicle or, maybe, only whether the motor vehicle moves or stands. By means of the safety device 10, the appliance, in the present case the motor vehicle, can be put into operation or the putting into operation can be prevented. This is symbolized in FIG. 1 by an ignition device 16. The safety device either permits closing of the circuit of the ignition or interrupts it.

The safety device 10 is a computer having a processor 18, a main memory 20, an auxiliary memory 22 and a ROM 24. A program memory 26 is connected with the ROM 24, as indicated by arrow 28. The processor 18 is connected with an input and output unit 30. This is illustrated by a double arrow 32.

Through the input and output unit 30, the processor 18 communicates with a reading and writing device 34. This is illustrated by a double arrow 36. The reading and writing device 34 communicates in both directions with the enabling element 12. This is illustrated by a double arrow 38.

Furthermore, the processor 18 communicates, through the input and output unit 30, with a finger print scanner 40. This is illustrated by the double arrow 41. This fingerprint scanner 40 detects ,upon actuation of an overriding device by the human operator the finger prints thereof. These finger prints can be stored.

Through the input and output unit 30, the processor 18 controls an indicating device 42, a recorder 44, the ignition device 16, and a signaling device 46. This is illustrated by the arrows 48, 50, 52 and 54, respectively. Numeral 56 designates a printer arranged to be driven by the processor 18. The driving connection is illustrated by an arrow 58. A clock 60 provides local time to the processor, as indicated by arrow 62. Eventually, there is also an emergency power supply, which is designated by 64. The emergency power supply 64 supplies the memories 20 and 22 and the clock 60.

The data from the components 14 are also applied to the processor 18 through the input and output unit 30. This is illustrated by an arrow 65.

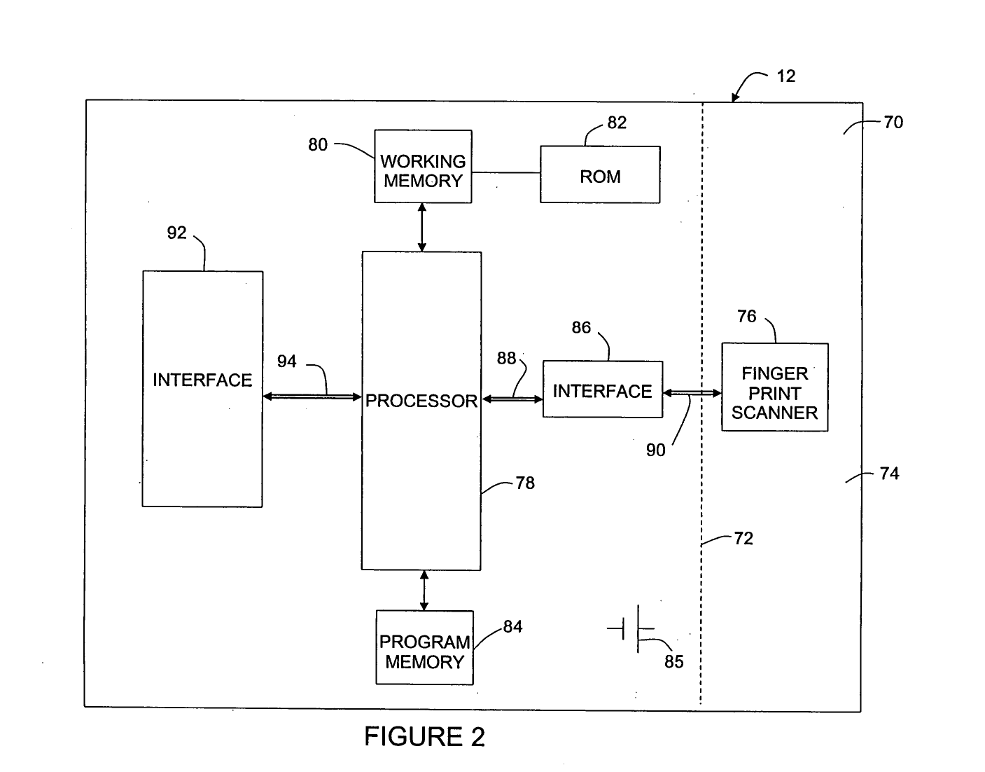

FIG. 2 schematically illustrates the setup of the enabling element 12. The enabling element 12 has the shape of a card and forms a flat, card-like housing 70. This card can be pushed into a slot of the safety device 10 up to a line 72. If this is done, an edge portion 74 extends out of the safety device 10. A finger print scanner 76 is provided on the edge portion. This fingerprint scanner 76 detects the finger print of a finger lying thereon and converts this finger print into a digital file, which represents the finger print.

The enabling element 12, in turn, forms an autonomous computer, which communicates with the computer of the safety device. The computer of the enabling element 12 has a processor 78 with a main memory 80, a ROM 82 and a program memory 84, as well as its own power supply 85. The processor communicates with the finger print scanner 76 through an interface 86. This is illustrated by the arrows 88 and 90. Furthermore, the processor 78 communicates with the safety device through an interface 92, as illustrated by arrow 94. The “means for comparing the recognized body characteristic” (finger print) with the body characteristic stored in the enabling element 12 consist of an appropriate program in the program memory 80. This program also fulfills the function of generating a release signal only in the case of identity of recognized and stored body characteristic.

Instead of a finger print, also another invariable body characteristic, for example the structure of the iris of the human operator can be stored and recognized.

The described arrangement operates as follows:

For putting the appliance, here a motor vehicle, into operation, the human operator (driver) requires an enabling element 12 in the form of a card 70. Such a card 70 is prepared. To this end, the driver's data are supplied and stored in the ROM 82, thus invariably, for example, name, first name, driver's license number, etc. In addition, however, the authority issuing the card 70 takes a finger print of the driver and stores this finger print in the ROM 82 in the form of a digital file. Storing finger prints in the form of a digital file is known per se from the police identification service and, therefore, is not described here in detail.

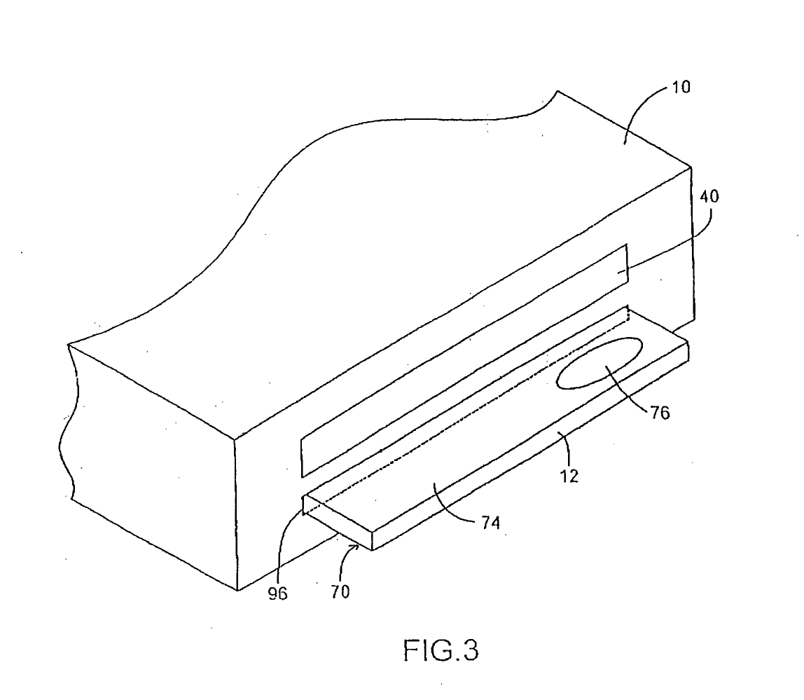

For putting the motor vehicle into operation, the driver has to insert the card 70 into a slot 96, FIG. 3, of the safety device 10. The safety device 10 has substantially the dimensions of a car radio. The slot 96 is provided in the lower portion of the front plate of the safety device 10. An indicating instrument 42, for example in the form of a LCD, is located above the slot 96. When the card 70 has not been inserted into the slot, the motor vehicle is out of operation, for example, by the circuit of the ignition being opened. This opening of the circuit-independent of the actuation or non-actuation of the ignition switch- is terminated only when the enabling element 12 supplies a release signal to the processor 18.

This release signal, however, is not simply generated by pushing the card 70 into the slot 96. First, an additional driver identification has to take place. Such additional driver identification is effected by the driver placing the finger, the finger prints of which are stored in the ROM 82, on the finger print scanner 76. The finger print scanner, again, provides a digital file which represents the finger print thus recognized of the driver. This recognized file is compared by the processor 78 with the finger print stored in the enabling element 12 when this was issued. Only when this comparison is positive, thus the identity of the finger prints is ascertained, the enabling element 12 provides a release signal applied to the processor 18 of the safety device10. This release signal terminates the interruption of the circuit and permits the putting into operation of the motor vehicle through the ignition switch. Provision can be made that such putting into operation is effected only if, during insertion of the card 70 into the slot 96, the driver's finger to be checked with respect to finger print lies on the fingerprint scanner. This ensures that only the authorized driver can push his card 70 into the slot 96 for putting the motor vehicle into operation.

When the motor vehicle has been started in this way and moves, then an optical or acoustical requesting signal is generated by the processor 78 of the enabling element (or the processor 18) through a signal device. After this requesting signal has been given, the driver has to place, within a short time, his finger on the finger print scanner 76. Then, a new comparison of the finger print recognized thereby with the finger print stored in the enabling element 12 takes place. An alarm signal is generated, if the finger prints are not identical. The requesting signals are generated either in a fixed, cyclic program sequence, or by means of a random event generator in random sequence. This is a question of the programming of the processor 78 or 18.

If the motor vehicle is shut down by the alarm signal, the -unauthorized- driver can actuate override means, which permit putting the moto vehicle in operation for a limited time, for example for driving the motor vehicle to a parking ground. However, to this end, the driver has to place a finger on a second finger print scanner 40. Thereby, the finger print is recognized and stored.

The described method with the requesting signals ensures that the authorized owner of the enabling element 12 not only has put the motor vehicle into operation but is actually on the wheel during the whole driving time. The requesting signals with the finger print scanner 76, in addition, act as a “dead man's button”. The driver has to react rather quickly to put his finger on the finger print scanner 76. If he does not do that within a predetermined time, this might be an indication of the driver being overtired.

“Occurrences” are stored in the memory 84 of the enabling element 12 through the reading and writing device 34 of the safety device. Such an “occurrrence”, at first, is the driving per se, the variation in time and in particular the duration of which is watched. This can be done similar to the embodiment described in DE 32 40 773 C2 in such a way, that a permissible driving time stored in the enabling element 12 is read out from the memory 84 by the reading and writing device 34 and a remaining driving time is written back in the memory 84 by the reading and writing device 34 depending on the respective actual driving time. It is, however, also possible to simply store the total driving times in the enabling element 12. The maximum permissible driving time is, indeed, fixed by the law. If this driving time has been reached, the driver is not allowed to continue to drive. The time is provided by the clock 60. Also this is just a question of programming the processor 78 or 18.

In such a case, a signal is given. This may be an optical or acoustical signal. The signal may, however, also consist in shutting down the motor vehicle.

In similar way as the driving times, also the driving speeds or other operational parameters, for example through GPS the driven route, can be watched and be stored in the main memory 84 of the enabling element. The data thus stored can then unambiguously be allotted to a particular driver.

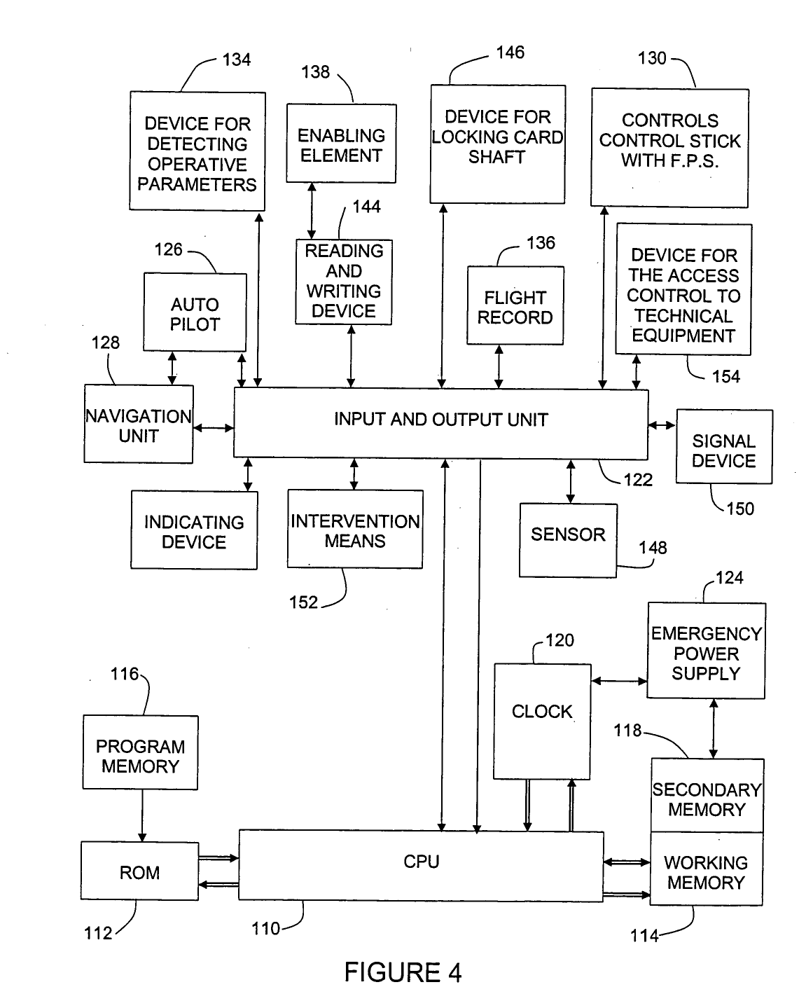

FIGS. 4 to 6, show, as another embodiment of the invention, a device for controlling the control means, for example the control stick, of aircraft to ensure that the aircraft can be flown by an authorized pilot only.

Referring to FIG. 4, numeral 110 designates a central processing unit of a safety unit. The central processing unit 110 is in data communication with a ROM 112 and a main or working memory 114. Numeral 116 designates a program memory, and numeral 118 designates a secondary memory. A clock 120 provides clock pulses for the data processing. The central processing unit 110 communicates with an interface or input-output unit 122. This is a conventional setup of a computer. The computer is provided with an integrated emergency power supply 124.

The aircraft has an autopilot 126 and a navigation unit 128. The autopilot 126 maintains heading and attitude of the aircraft against outside disturbances. The navigation unit provides the position of the aircraft for example by inertial navigation and satellite navigation (GPS). By means of controls 130, among others, a control stick 132, the pilot can influence the autopilot 126 through the interface and can change the heading or attitude.

Numeral 134 designates a device for measuring operational parameters. A flight recorder 136 records the various flight data.

As a safeguard against unauthorized setting into operation of the aircraft or against terrorist elimination of the legitimate pilot, an enabling element 138 in the form of a chip card or code card is provided. Data about the respective authorized pilot are stored on this enabling element 138 or chip card. In particular, the enabling element 138 contains digitally stored body characteristics of the pilot such as his finger-prints. This enabling element 138 is inserted into a card intake shaft 140 of a safety unit, which is illustrated as a box 142 in FIG. 6. In the safety unit 142, the digitally stored finger-print is read out by a reading and writing unit 144 and is stored through the central processing unit 110. The card input shaft 140 will then be closed and locked by means of a locking device 146. Then, the enabling element 138 is no longer accessible during the whole flight.

In order to ensure, from the beginning, that actually the rightful owner of the enabling element (chip card) 138 inserts this enabling element into the card input shaft, the enabling element 138 itself is provided with a sensor 147 which responds to the respective body characteristic, in the present case a finger-print scanner. The enabling element 138 contains means for comparing the finger print detected by sensor 147 with the stored finger-print. At first, the enabling element is pulled into an intermediate position in the card input shaft 140. In this intermediate position, the pilot has to hold the card with his thumb in the area of the finger-print scanner, such that the finger-print can be detected. If the comparison with the stored finger-print has a positive result, the card will be pulled into the card input shaft 140 and is no longer accessible, after the card input shaft has been locked. If the result of the comparison is negative, setting into operation of the aircraft is prevented.

If the aircraft is flown by more than one pilot, all pilots must, of course, insert their enabling elements into associated card input shafts.

Instead of the finger-prints, voice recognition means can be provided, from which voice characteristics can be derived as invariable body characteristics by the enabling element or the safety unit.

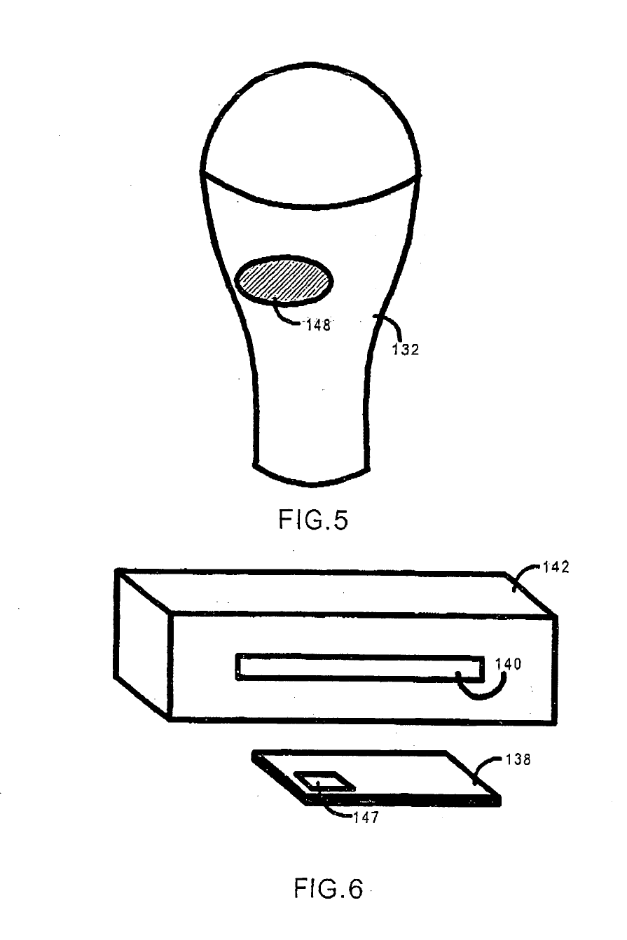

By means of a sensor 148 or sensors at the controls, the finger-print of the real pilot is also detected in digital form, when the pilot handles the controls. This sensor represents “recognizing means” for recognizing the body characteristic of the pilot or the person intending to fly the aircraft. In FIG.5, such a sensor 148 is schematically shown at the control stick of the aircraft. When the pilot wants to actuate the control stick, he has to touch this sensor 148 with a particular finger. The sensor provides a digital “image” of the finger-print. This digital image is applied to the central processing unit 110 through the interface or input-output-unit 122. By means of appropriate image processing, this digital image can be caused to coincide with the digitally stored finger-print. Then, the computer with the central processing unit 110 compares the digital image of the finger-print provided by the sensor with the stored digital finger-print from the enabling element. If these finger-prints are identical, then the pilot, whose enabling element 138 or chip card has been inserted into the card input shaft is, indeed, at the controls. The controls operate normally.

If the finger-prints do not coincide, the controls are disabled. Therefore, any other person than the rightful owner of the enabling element 138 cannot set the aircraft into operation and take off. Additional data in the enabling element may ensure that the pilot is entitled to fly the particular type of aircraft.

If, during the flight, the authorized pilot is subdued and eliminated by terrorists, then no other person can fly the aircraft in his place. There is no longer identity of the finger-prints, which is detected by the computer with the central processing unit 110. If the aircraft is in the air, the aircraft will automatically be changed over to a forced autopilot operation which cannot be influenced by that other person. The person taking the place of the pilot cannot influence the trajectory and attitude of the aircraft. At first, the autopilot operation does not involve any risk for the aircraft. The aircraft cannot crash due to maloperation.

An alarm signal is transmitted to a ground station by means of a signal transmitter unit 150. Then the ground station knows that the authorized pilot is no longer at the controls. The control of the aircraft is then changed over to remote control, the autopilot getting commands from the ground station through intervention means. These commands serve to guide the aircraft to the nearest airport. There, a remote controlled or automatic landing is initiated. The persons in the cockpit have no influence on this procedure.

It could happen, that an authorized pilot having a regular enabling element turns out to be a terrorist himself and attempts to suicidally steer the aircraft into a target. In this case, prohibited areas, which no aircraft is allowed to enter, are stored in the memory 114 or 118. The navigation unit 128 always provides the exact position of the aircraft. Therefore, the computer will detect if the aircraft enters such prohibited area. In this case also, when entering this prohibited area, the controls are automatically changed over to the forced autopilot operation, which can no longer be influenced by the pilot. The controls can then automatically be actuated in such a way that they lead the aircraft away from the prohibited area. In similar way, forced change-over to autopilot operation can be effected, if the pilot makes flight manoeuvres which, from the present position of the aircraft, would involve the risk of collision with an obstacle, such as a building, or unusual flight manoeuvres such as a steep descent from low altitude and outside an airport. Then the generation of an alarm signal, the remote control and the automatic landing take place in the manner described above.

In all cases, in addition to the autopilot, also all other enabling elements such as throttle lever, flap lever, etc. are secured against further manipulation. This is illustrated by block 154 in FIG.4.

The changing over to forced autopilot operation and, if necessary, automatic or remote controlled landing in the case of terrorist activities or unusual behavior of the pilot may be provided also independently of the described checking of a body characteristic of the pilot.

Instead of the finger-print or a plurality of finger-prints, also another body characteristic may be detected by a sensor. For example, the sensor may be an iris scanner which scans the structure of the pilot's iris. In this case, the pilot can be asked, at random sequence, to fix on a particular mark, whereby a well-defined position of the eye relative to an iris scanner is established. In similar way, the pilot may be requested by commands, at random sequence, to provide a vocal test, for example tell the respective time. The voice characteristics can be derived from this announcement and can be compared to voice characteristics stored in the safety unit.

1. Method of controlling an appliance, which cooperates with a human operator, characterized by the steps:
(a) making an enabling element, which is provided with memory means and associated with a particular, authorized human operator,
(b) storing an invariable body characteristic in the memory of the enabling element,
(c) releasing the appliance for operation by using the enabling element by the authorized human operator,
(d) during this use, carrying out a comparison of the body characteristic of the human operator with the stored body characteristic,
(e) preventing the release, when the body characteristics deviate from each other.

2. Method as claimed in claim 1, characterized in that occurrences in the watched appliance are stored in the memory of the enabling element.

3. Method as claimed in claim 1 or 2, characterized in that a signal is generated with intolerable occurrences in the appliance.

4. A method as claimed in anyone of the claims 1 to 3, characterized in that the appliance is a motor vehicle and the human operator is the driver of the vehicle.

5. Method as claimed in claim 4, characterized in that the occurrence watched is the driving time performed by the driver within a predetermined period of time, the watching relating to exceeding of a maximum permissible driving time.

6. Method as claimed in anyone of the claims 1 to 5, characterized in that one or more finger prints are detected as invariable body characteristic and are stored digitally, under supervision, in the enabling element.

7. Method as claimed in anyone of the claims 1 to 5, characterized in that the iris structure is detected as invariable body characteristic and is stored, under supervision, in the enabling element.

8. Method as claimed in anyone of the claims 1 to 5, characterized in that voice characteristics are detected as invariable body characteristic and are stored, under supervision, in the enabling element.

9. Method as claimed in anyone of the claims 1 to 8, characterized in that requesting signals are generated in time intervals, these requesting signals requesting the human operator to expose the body characteristic for recognition, an alarm signal being generated, if this request is not met within a predetermined time.

10. Device for controlling an appliance, which cooperates with a human operator, wherein the appliance contains an appliance-side safety device (10,142), on which an enabling element (12;138) provided with memory means (80,82,84) and associated with a particular, authorized human operator is used, the appliance being operable only after the use of the enabling element (12;138), characterized by means for storing an invariable body characteristic of the authorized human operator, means (76) for recognizing this body characteristic of the human operator using the enabling element (12;138) on the safety device (10;142), and means for comparing the recognized body characteristic with the body characteristic stored in the enabling element (12;138), allowing operation of the appliance only after use of the enabling element (12;138) and only then when the recognized and stored body characteristics are identical.

11. Device as claimed in claim 10, characterized in that occurrences in the device to be controlled can be stored in the memory means (84) of the enabling element (12).

12. Device as claimed in claim 11, characterized by signal means (44) which respond to intolerable occurrences.

13. Device as claimed in anyone of the claims 10 to 12, characterized in that the invariable body characteristic is one or more finger prints, which are stored digitally in the enabling element (12;138), and the means for recognizing the body feature are a finger print scanner (78;148).

14. Device as claimed in claim 10, characterized in that means (76;148) for recognizing the body characteristic of the human operator using the enabling element (12;138) on the appliance (10;142) and means for comparing the recognized body characteristic with the body characteristic stored in the enabling element (12;138) are provided on the enabling element (12;138), the enabling element (12;138) applying a release signal to the safety device provided on the appliance then and only then, when the result of the comparison is positive.

15. Device as claimed in claim 14, characterized in that the enabling element (12) is a flat, card-like element (70) which can be inserted into a slot (96) of the safety device (10), and the means (76) for recognizing the body characteristic represented by a finger print are provided in an edge area (74) of the enabling element (12), which edge area extends from the safety device (10), after the enabling element (12) has been inserted, and the release signal is generated only, when the enabling element (12), when being inserted into the safety device (10) is held in the range of these means (76) with the finger having the stored finger print.

16. Device as claimed in claim 14 or 15, characterized in that the enabling element (12) is an autonomous computer having processor (78), program and main memories (80,84) and interface (92) to the appliance-side safety device (10).

17. Device as claimed in anyone of the claims 10 to 16, characterized by means for generating requesting signals in time intervals, these requesting signals requesting the human operator to expose the body characteristic to be compared for recognition, and means for generating an alarm signal, which respond, when this request is not met within a predetermined time.

18. Device as claimed in claim 17, characterized in that the appliance can be made inoperative by the alarm signal, and overriding means are provided, by which the appliance, after having been made inoperative, can be made operative for a limited period of time, the overriding means comprising means (40) for recognizing and storing an invariable body characteristic of the person actuating the overriding means.

19. Device as claimed in claim 10, for controlling the control means of aircraft to ensure that the aircraft can be flown by an authorized pilot only, characterized in that
(a) the control means comprise a safety device (142), on which an enabling element (138) associated with a particular pilot can be used, the control means being arranged to be activated only after use of the enabling element,
(b) the enabling element (138) has means for storing an invariable body characteristic of the authorized pilot,
(c) recognizing means for recognizing this body characteristic on the person handling the control means,
(d) comparison means for comparing the recognized body characteristic with the body characteristic stored in the enabling element, and
(e) the control means are compulsorily deactivated in the case of a deviation between recognized and stored body characteristic.

20. Device as claimed in claim 19, characterized in that the enabling element has a sensor, which responds to a finger print of the user detected during the insertion of the enabling element into a card slot or the like, and means for comparing the finger print thus detected with a finger print stored as a body characteristic, putting into operation of the aircraft being prevented, if the result of the comparison is negative.

21. Device as claimed in claim 19 or 20, characterized in that the control means, in the case of a compulsory deactivation, are automatically changed over to a forced autopilot operation, which can no longer be influenced from within the aircraft.

22. Device as claimed in anyone of the claims 19 to 21, characterized in that the recognizing means comprise sensor means (148) for continuously recognizing the body characteristics.

23. Device as claimed in anyone of the claims 19 to 22, characterized in that
(a) the stored body characteristics are digitally stored finger prints of the authorized pilot and
(b) sensor means (148) responding to finger prints are provided at locations at the control elements (132) of the control means to be touched by the pilot's fingers.

24. Device as claimed in anyone of the claims 19 to 23, characterized in that the enabling element (138) is inaccessibly locked in the safety device (142) until the flight has been completed.

25. Device for Monitoring the pilot of an aircraft steerable by the pilot through control means, characterized in that
(a) a safety device (142) is provided, which cooperates with navigation means (128) for determining the position of the aircraft,
(b) the safety device (142), furthermore, comprises memory means for storing exclusion areas, and
(c) the control means, upon entering an exclusion area, are automatically switched over to a forced autopilot operation which can no longer be influenced by the pilot.

26. Device as claimed in claim 25, characterized in that the airplane, upon switching over to forced autopilot operation, is automatically led away from the exclusion area.

27. Device as claimed in claim 21, 25 or 26, characterized in that, upon changing over to forced autopilot operation, an alarm signal is transmitted to a ground station.

28. Device as claimed in claim 27, characterized in that intervention means (152) for remote control of the airplane from the ground station and for initiating an automatic or remote-controlled landing are provided.

29. Device as claimed in anyone of the claims 19 to 24, characterized in that the recognizing means have an iris scanner.

30. Device as claimed in anyone of the claims 19 to 24, characterized in that the recognizing means comprise means for recognizing voice characteristics.

31. Device as claimed in claim 29, characterized in that the safety device comprises means for generating requesting signals, by which the pilot, in irregular time intervals, is requested to assume a particular eye position to permit detection of the iris structure by the iris scanner.

32. Device as claimed in claim 30, characterized in that the safety device comprises means for generating requesting signals, by which the pilot, in irregular time intervals, is requested to speak certain words to permit detection of voice characteristics.

33. Enabling element which permits a human operator to cooperate with an appliance, characterized by means for storing an invariable body characteristic of an authorized human operator, means for recognizing these body characteristic of the human operator, means for comparing the stored and recognized body characteristics, and means for generating a release signal only when the recognized and the stored body characteristics are identical.

34. Enabling element as claimed in claim 33, characterized in that the enabling element is an autonomous computer unit having processor (78), program and main memories (80,84) and interface (92).

35. Enabling element as claimed in claim 33 or 34, characterized in that the means for recognizing the body characteristic are a finger print scanner.

36. Enabling element as claimed in claim 37, characterized in that it is designed as a flat, card-like element, which, for use on an appliance, has to be held, in the area of the finger print scanner, by a finger the print of which is stored in the enabling element.

37. Enabling element as claimed in anyone of the claims 33 to 36, characterized in that it is provided with its own power supply (85).

38. Enabling element as claimed in claim 34, characterized by an interface (92) to a safety device (10) for the watching of occurrences within the appliance, memory means (80,84) from which data can be read into the safety device (10) through the interface, and in which data from the safety device can be written through the interface.

39. Device for controlling the control means of aircraft to ensure that the aircraft can be flown by an authorized pilot, characterized in that control means can be de-activated upon an attempt of a terrorist take-over of the aircraft, and can be changed over, upon such forced de-activation, to a forced autopilot operation which can no longer be influenced from inside the aircraft.
